(19) United States
(12) Patent Application Publication
(10) Pub. No.: US 2016/0253697 A1
(43) Pub. Date: Sep. 1, 2016

(54) SITE-WIDE IMPACT

(71) Applicant: Linkedln Corporation, Mountain View, CA (US)

(72) Inventors: Ya Xu, Los Altos, CA (US); Omar Sinno, San Francisco, CA (US); Adrian Axel Remigo Fernandez, Mountain View, CA (US); Nanyu Chen, San Francisco, CA (US); Kylan Matthew Nieh, Fremont, CA (US)

(21) Appl. No.: 14/944,015

(22) Filed: Nov. 17, 2015

Related U.S. Application Data
(60) Provisional application No. 62/126,169, filed on Feb. 27, 2015.
(60) Provisional application No. 62/141,126, filed on Mar. 31, 2015.

(51) Int. Cl. G06Q 30/02; G06F 17/30; G06F 3/0484; H04L 29/08; G06F 17/22

(52) U.S. Cl. CPC G06Q 30/0243; H04L 67/02; G06F 17/2288; G06F 3/0484; G06F 17/30899; G06F 17/30867

(57) ABSTRACT

Techniques for conducting A/B experimentation of online content are described. According to various embodiments, a site-wide impact value for an A/B experiment that is associated with a metric is calculated, the site-wide impact value indicating a predicted percentage change in the value of a metric responsive to application of a treatment variant to an entire portion of a targeted segment of members, in comparison to application of a control variant to an entire portion of the targeted segment of members.

### RELATED APPLICATIONS

This application claims the benefit of priority to U.S. Provisional Application Ser. No. 62/126,169, filed Feb. 27, 2015, and U.S. Provisional Application Ser. No. 62/141,126, filed Mar. 31, 2015, which are incorporated herein by reference in their entirety.

### TECHNICAL FIELD

The present application relates generally to data processing systems and, in one specific example, to techniques for conducting A/B experimentation of online content.

### BACKGROUND

The practice of A/B experimentation, also known as “A/B testing” or “split testing,” is a practice for making improvements to webpages and other online content. A/B experimentation typically involves preparing two versions (also known as variants, or treatments) of a piece of online content, such as a webpage, a landing page, an online advertisement, etc., and providing them to separate audiences to determine which variant performs better.

### BRIEF DESCRIPTION OF THE DRAWINGS

Some embodiments are illustrated by way of example and not limitation in the figures of the accompanying drawings in which:

FIG. 1 is a block diagram showing the functional components of a social networking service, consistent with some embodiments of the present disclosure;

FIG. 2 is a block diagram of an example system, according to various embodiments;

FIG. 3 is a diagram illustrating a targeted segment of members, according to various embodiments;

FIG. 4 illustrates an example portion of a user interface, according to various embodiments;

FIG. 5 is a flowchart illustrating an example method, according to various embodiments;

FIG. 6 illustrates an example mobile device, according to various embodiments; and

FIG. 7 is a diagrammatic representation of a machine in the example form of a computer system within which a set of instructions, for causing the machine to perform any one or more of the methodologies discussed herein, may be executed.

### DETAILED DESCRIPTION

Example methods and systems for conducting A/B experimentation of online content are described. In the following description, for purposes of explanation, numerous specific details are set forth in order to provide a thorough understanding of example embodiments. It will be evident, however, to one skilled in the art that the embodiments of the present disclosure may be practiced without these specific details.

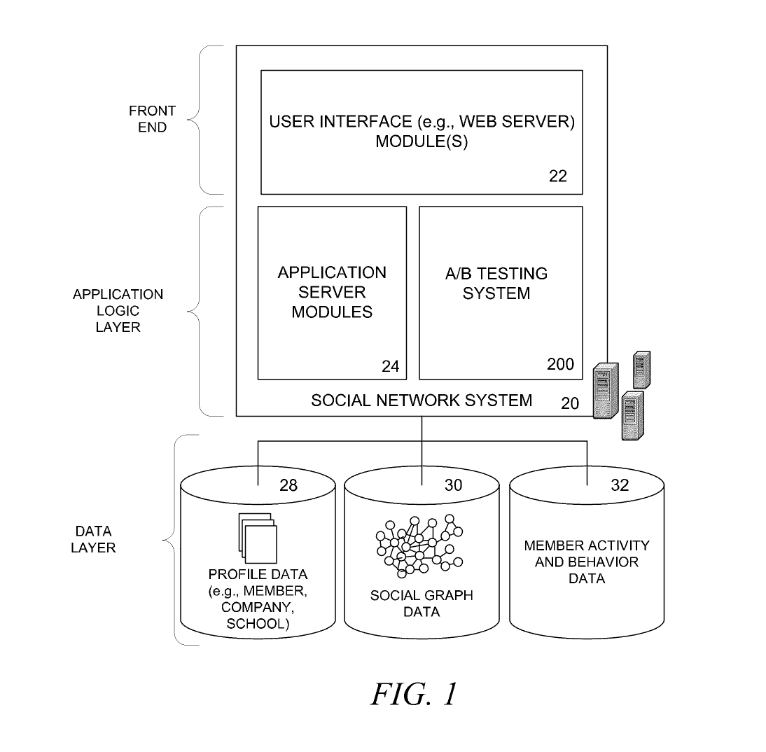

FIG. 1 is a block diagram illustrating various components or functional modules of a social network service such as the social network system 20, consistent with some embodiments. As shown in FIG. 1, the front end consists of a user interface module (e.g., a web server) 22, which receives requests from various client-computing devices, and communicates appropriate responses to the requesting client devices. For example, the user interface module(s) 22 may receive requests in the form of Hypertext Transport Protocol (HTTP) requests, or other web-based, application programming interface (API) requests. The application logic layer includes various application server modules 14, which, in conjunction with the user interface module(s) 22, generates various user interfaces (e.g., web pages) with data retrieved from various data sources in the data layer. With some embodiments, individual application server modules 24 are used to implement the functionality associated with various services and features of the social network service. For instance, the ability of an organization to establish a presence in the social graph of the social network service, including the ability to establish a customized web page on behalf of an organization, and to publish messages or status updates on behalf of an organization, may be services implemented in independent application server modules 24. Similarly, a variety of other applications or services that are made available to members of the social network service will be embodied in their own application server modules 24.

As shown in FIG. 1, the data layer includes several databases, such as a database 28 for storing profile data, including both member profile data as well as profile data for various organizations. Consistent with some embodiments, when a person initially registers to become a member of the social network service, the person will be prompted to provide some personal information, such as his or her name, age (e.g., birthdate), gender, interests, contact information, hometown, address, the names of the member's spouse and/or family members, educational background (e.g., schools, majors, matriculation and/or graduation dates, etc.), employment history, skills, professional organizations, and so on. This information is stored, for example, in the database with reference number 28. Similarly, when a representative of an organization initially registers the organization with the social network service, the representative may be prompted to provide certain information about the organization. This information may be stored, for example, in the database with reference number 28, or another database (not shown). With some embodiments, the profile data may be processed (e.g., in the background or offline) to generate various derived profile data. For example, if a member has provided information about various job titles the member has held with the same company or different companies, and for how long, this information can be used to infer or derive a member profile attribute indicating the member's overall seniority level, or seniority level within a particular company. With some embodiments, importing or otherwise accessing data from one or more externally hosted data sources may enhance profile data for both members and organizations. For instance, with companies in particular, financial data may be imported from one or more external data sources, and made part of a company's profile.

Once registered, a member may invite other members, or be invited by other members, to connect via the social network service. A “connection” may require a bi-lateral agreement by the members, such that both members acknowledge the establishment of the connection. Similarly, with some embodiments, a member may elect to “follow” another member. In contrast to establishing a connection, the concept of “following” another member typically is a unilateral operation, and at least with some embodiments, does not require acknowledgement or approval by the member that is being followed. When one member follows another, the member who is following may receive status updates or other messages published by the member being followed, or relating to various activities undertaken by the member being followed. Similarly, when a member follows an organization, the member becomes eligible to receive messages or status updates published on behalf of the organization. For instance, messages or status updates published on behalf of an organization that a member is following will appear in the member's personalized data feed or content stream. In any case, the various associations and relationships that the members establish with other members, or with other entities and objects, are stored and maintained within the social graph, shown in FIG. 1 with reference number 30.

The social network service may provide a broad range of other applications and services that allow members the opportunity to share and receive information, often customized to the interests of the member. For example, with some embodiments, the social network service may include a photo sharing application that allows members to upload and share photos with other members. With some embodiments, members may be able to self-organize into groups, or interest groups, organized around a subject matter or topic of interest. With some embodiments, the social network service may host various job listings providing details of job openings with various organizations.

As members interact with the various applications, services and content made available via the social network service, the members' behavior (e.g., content viewed, links or member-interest buttons selected, etc.) may be monitored and information concerning the member's activities and behavior may be stored, for example, as indicated in FIG. 1 by the database with reference number 32.

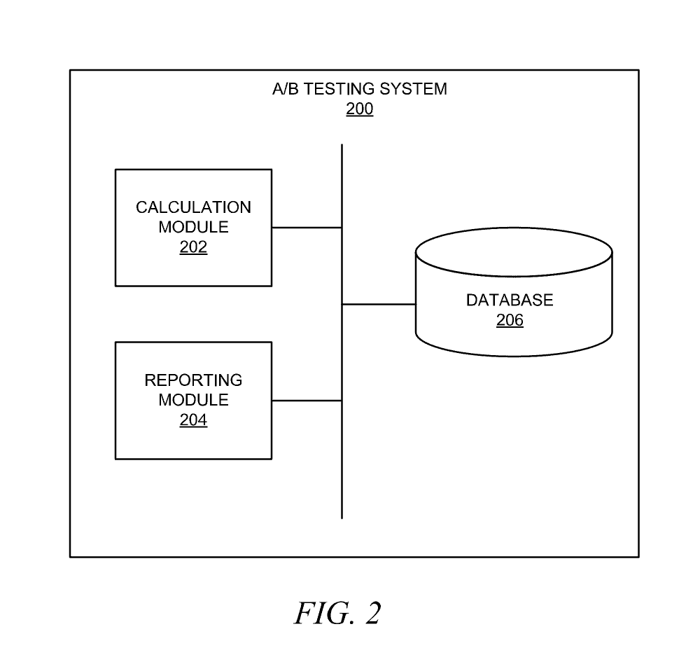

With some embodiments, the social network system 20 includes what is generally referred to herein as an A/B testing system 200. The A/B testing system 200 is described in more detail below in conjunction with FIG. 2.

Although not shown, with some embodiments, the social network system 20 provides an application programming interface (API) module via which third-party applications can access various services and data provided by the social network service. For example, using an API, a third-party application may provide a user interface and logic that enables an authorized representative of an organization to publish messages from a third-party application to a content hosting platform of the social network service that facilitates presentation of activity or content streams maintained and presented by the social network service. Such third-party applications may be browser-based applications, or may be operating system-specific. In particular, some third-party applications may reside and execute on one or more mobile devices (e.g., phone, or tablet computing devices) having a mobile operating system.

According to various example embodiments, an A/B experimentation system is configured to enable a user to prepare and conduct an A/B experiment of online content among members of an online social networking service such as LinkedIn®. The A/B experimentation system may display a targeting user interface allowing the user to specify targeting criteria statements that reference members of an online social networking service based on their member attributes (e.g., their member profile attributes displayed on their member profile page, or other member attributes that may be maintained by an online social networking service that may not be displayed on member profile pages). In some embodiments, the member attribute is any of location, role, industry, language, current job, employer, experience, skills, education, school, endorsements of skills, seniority level, company size, connections, connection count, account level, name, username, social media handle, email address, phone number, fax number, resume information, title, activities, group membership, images, photos, preferences, news, status, links or URLs on a profile page, and so forth. For example, the user can enter targeting criteria such as “role is sales”, “industry is technology”, “connection count>500”, “account is premium”, and so on, and the system will identify a targeted segment of members of an online social network service satisfying all of these criteria. The system can then target all of these users in the targeted segment for online A/B experimentation.

Once the segment of users to be targeted has been defined, the system allows the user to define different variants for the experiment, such as by uploading files, images, HTML code, webpages, data, etc., associated with each variant and providing a name for each variant. One of the variants may correspond to an existing feature or variant, also referred to as a “control” variant, while the other may correspond to a new feature being tested, also referred to as a “treatment”. For example, if the A/B experiment is testing a user response (e.g., click through rate or CTR) for a button on a homepage of an online social networking service, the different variants may correspond to different types of buttons such as a blue circle button, a blue square button with rounded corners, and so on. Thus, the user may upload an image file of the appropriate buttons and/or code (e.g., HTML code) associated with different versions of the webpage containing the different variants.

Thereafter, the system may display a user interface allowing the user to allocate different variants to different percentages of the targeted segment of users. For example, the user may allocate variant A to 10% of the targeted segment of members, variant B to 20% of the targeted segment of members, and a control variant to the remaining 70% of the targeted segment of members , via an intuitive and easy to use user interface. The user may also change the allocation criteria by, for example, modifying the aforementioned percentages and variants. Moreover, the user may instruct the system to execute the A/B experiment, and the system will identify the appropriate percentages of the targeted segment of members and expose them to the appropriate variants.

Turning now to FIG. 2, an A/B testing system 200 includes a calculation module 202, a reporting module 204, and a database 206. The modules of the A/B testing system 200 may be implemented on or executed by a single device such as an A/B testing device, or on separate devices interconnected via a network. The aforementioned A/B testing device may be, for example, one or more client machines or application servers. The operation of each of the aforementioned modules of the A/B testing system 200 will now be described in greater detail in conjunction with the various figures.

To run an experiment, the A/B testing system 200 allows a user to create a testKey, which is a unique identifier that represents the concept or the feature to be tested. The A/B testing system 200 then creates an actual experiment as an instantiation of the testKey, and there may be multiple experiments associated with a testKey. Such hierarchical structure makes it easy to manage experiments at various stages of the testing process. For example, suppose the user wants to investigate the benefits of adding a background image. The user may begin by diverting only 1% of US users to the treatment, then increasing the allocation to 50% and eventually expanding to users outside of the US market. Even though the feature being tested remains the same throughout the ramping process, it requires different experiment instances as the traffic allocations and targeting changes. In other words, an experiment acts as a realization of the testKey, and only one experiment per testKey can be active at a time.

Every experiment is comprised of one or more segments, with each segment identifying a subpopulation to experiment on. For example, a user may set up an experiment with a “whitelist” segment containing only the team members developing the product, an “internal” segment consisting of all company employees and additional segments targeting external users. Because each segment defines its own traffic allocation, the treatment can be ramped to 100% in the whitelist segment, while still running at 1% in the external segments. Note that segment ordering matters because members are only considered as part of the first eligible segment. After the experimenters input their design through an intuitive User Interface, all the information is then concisely stored by the A/B testing system 200 in a DSL (Domain Specific Language). For example, the line below indicates a single segment experiment targeting English-speaking users in the US where 10% of them are in the treatment variant while the rest in control.

(ab(=(locale)“en_US”)[treatment 10% control 90%])

In some embodiments, the A/B testing system 200 may log data every time a treatment for an experiment is called, and not simply for every request to a webpage on which the treatment might be displayed. This not only reduces the logs footprint, but also enables the A/B testing system 200 to perform triggered analysis, where only users who were actually impacted by the experiment are included in the A/B test analysis. For example, LinkedIn.com could have 20 million daily users, but only 2 million of them visited the “jobs” page where the experiment is actually on, and even fewer viewed the portion of the “jobs” page where the experiment treatment is located. Without such trigger information, it is difficult to isolate the real impact of the experiment from the noise, especially for experiments with low trigger rates.

Conventional A/B testing reports may not accurately represent the global lift that will occur when the winning treatment is ramped to 100% of the targeted segment (holding everything else constant). The reason is two-fold. Firstly, most experiments only target a subset of the entire user population (e.g., US users using an English language interface, as specified by the command “interface-locale=en_US”). Secondly, most experiments only trigger for a subset of their targeted population (e.g., members who actually visit a profile page where an experiment resides). In other words, triggered analysis only provides evaluation of the local impact, not the global impact of an experiment.

According to various example embodiments, the A/B testing system 200 is configured to compute a Site-wide Impact value, defined as the percentage delta between two scenarios or “parallel universes”: one with treatment applied to only targeted users and control to the rest, the other with control applied to all. Put another way, the site-wide impact is the x % delta if a treatment is ramped to 100% of its targeting segment. With site-wide impact provided for all experiments, users are able to compare results across experiments regardless of their targeting and triggering conditions. Moreover, Site-wide Impact from multiple segments of the same experiment can be added up to give an assessment of the total impact.

For most metrics that are additive across days, the A/B testing system 200 may simply keep a daily counter of the global total and add them up for any arbitrary date range. However, there are metrics, such as the number of unique visitors, which are not additive across days. Instead of computing the global total for all date ranges that the A/B testing system 200 generates reports for, the A/B testing system 200 estimates them based on the daily totals, saving more than 99% of the computation cost without sacrificing a great deal of accuracy.

In some embodiments, the average number of clicks is utilized as an example metric to show how the A/B testing system 200 computes Site-wide Impact. Let Xₜ, X_{c}, X_{seg} and X_{global} denote the total number of clicks in the treatment group, the control group, the whole segment (including the treatment, the control and potentially other variants) and globally across the site, respectively. Similarly, let nₜ, n_{c}, n_{seg} and n_{global} denote the sample sizes for each of the four groups mentioned above.

The total number of clicks in the treatment (control) universe can be estimated as:

$${X}_{t Universe} = \frac{{X}_{t}}{{n}_{t}} {n}_{seg} + ( {X}_{global} - {X}_{seg} )$$

$${X}_{c Universe} = \frac{{X}_{c}}{{n}_{c}} {n}_{seg} + ( {X}_{global} - {X}_{seg} )$$

Then the Site-wide Impact is computed as

$$\begin{matrix}SWI = ( \frac{{X}_{t Universe}}{{n}_{t Universe}} - \frac{{X}_{c Universe}}{{n}_{c Universe}} ) \text{/} \frac{{X}_{c Universe}}{{n}_{c Universe}} \\ = ( \frac{\frac{{X}_{t}}{{n}_{t}} - \frac{{X}_{c}}{{n}_{c}}}{\frac{{X}_{c}}{{n}_{c}}} ) \times ( \frac{\frac{{X}_{c}}{{n}_{c}} {n}_{seg}}{\frac{{X}_{c}}{{n}_{c}} {n}_{seg} + {X}_{global} - {X}_{seg}} ) \\ = Δ \times α\end{matrix}$$

which indicates that the Site-wide Impact is essentially the local impact Δ scaled by a factor of α. For metrics such as average number of clicks, Xglobal for any arbitrary date range can be computed by summing over clicks from corresponding single days. However, for metrics such as average number of unique visitors, de-duplication is necessary across days. To avoid having to compute α for all date ranges that the A/B testing system 200 generate reports for, the A/B testing system 200 estimates cross-day α by averaging the single-day α's. Another group of metrics include a ratio of two metrics. One example is Click-Through-Rate, which equals Clicks over Impressions. The derivation of Site-wide Impact for ratio metrics is similar, with the sample size replaced by the denominator metric.

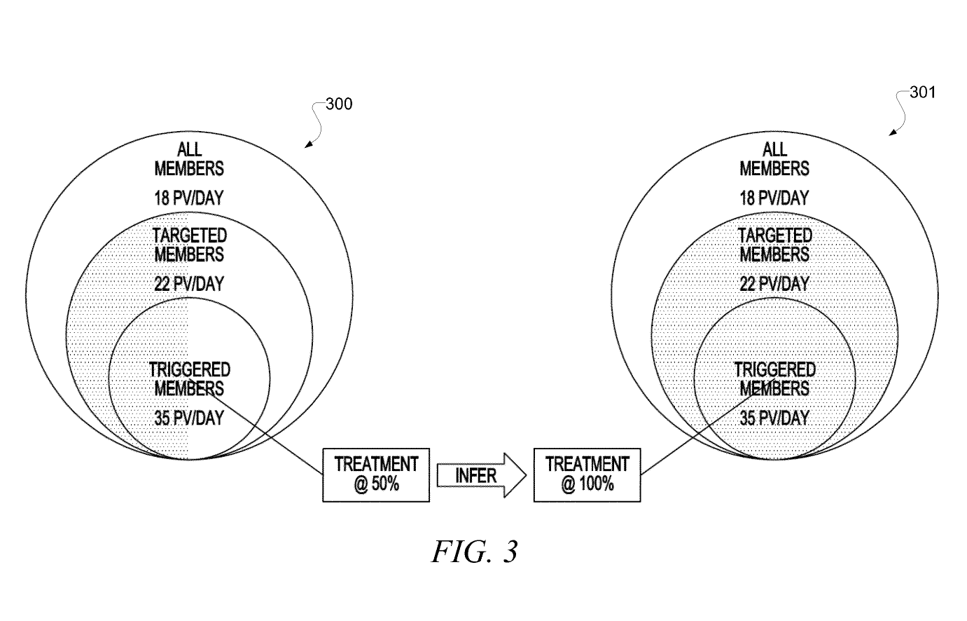

As illustrated in FIG. 3, in portion 300 an experiment may be targeted at a targeted segment of members or “targeted members”, who are a subpopulation of “all members” of an online social networking service. Moreover, the experiment will only be triggered for triggered members”, which is the subpopulation of the “targeted members” who are actually impacted by the experiment (e.g., that actually interact with the treatment). In portion 300, the treatment is only ramped to 50% of the targeted segment of members, and various metrics about the improvement of the treatment may be obtained as a result (e.g., a treatment page view metric that may be compared to a control page view metric). As illustrated in portion 301, the techniques described herein may be utilized to infer the improvement of the treatment variant if the treatment would be ramped to 100% of the targeted segment. More specifically, the A/B testing system 200 may infer the percentage improvement if the treatment variant is applied to 100% of the targeted segment, in comparison to the control variant being applied to 100% of the targeted segment.

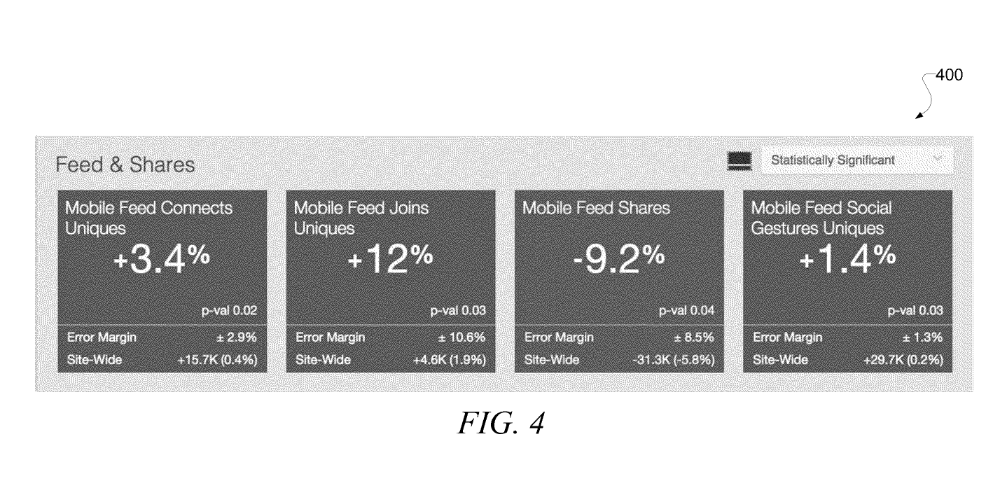

For example, FIG. 4 illustrates an example of user interface 400 that displays the % delta increase in the values of various metrics during an A/B experiment. Moreover, the user interface 400 indicates the site-wide impact of each metric, including a % delta increase/decrease.

In some example embodiments, a selection (e.g., by a user) of the “Statistically Significant” drop-down bar illustrated in FIG. 4 shows which comparisons (e.g., variant 1 vs. variant 4, or variant 6 vs. variant 12) are statistically significant.

In certain example embodiments, the user interface 400 provides an indication of the Absolute Site-wide Impact value, the percentage Site-wide Impact value, or both. For example, as illustrated in FIG. 4, for Mobile Feed Connects Uniques, the Absolute Site-wide Impact value is “+15.7K,” and the percentage Site-wide Impact value is “0.4%.”

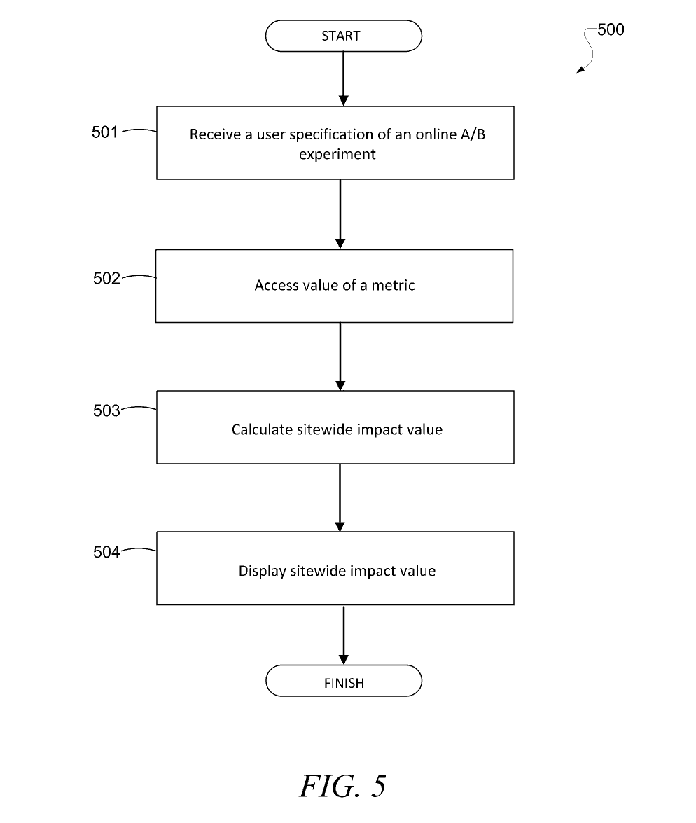

FIG. 5 is a flowchart illustrating an example method 500, consistent with various embodiments described herein. The method 500 may be performed at least in part by, for example, the A/B testing system 200 illustrated in FIG. 2 (or an apparatus having similar modules, such as one or more client machines or application servers). In operation 501, the calculation module 202 receives a user specification of an online A/B experiment of online content being targeted at a segment of members of an online social networking service, a treatment variant of the A/B experiment being applied to (or triggered by) a subset of the segment of members. In operation 502, the calculation module 202 accesses a value of a metric associated with application of the treatment variant of the A/B experiment to the subset of the segment of members in operation 501. In operation 503, the calculation module 202 calculates a site-wide impact value for the A/B experiment that is associated with the metric, the site-wide impact value indicating a predicted percentage change in the value of the metric (identified in operation 502) responsive to application of the treatment variant to 100% of the targeted segment of members, in comparison to application of the control variant to 100% of the targeted segment of members. In operation 504, the reporting module 204 displays, via a user interface displayed on a client device, the site-wide impact value calculated in operation 503. It is contemplated that the operations of method 500 may incorporate any of the other features disclosed herein. Various operations in the method 500 may be omitted or rearranged, as necessary.

### EXAMPLE EMBODIMENTS

As described in greater detail below, site-wide impact may be computed by the system 200 differently for three types of metrics: count metrics (e.g., page views), ratio metrics (e.g., CTR), and unique metrics (e.g., number of unique visitors).

In these examples there are two variants (treatment & control) being compared against each other. Both variants are within the same segment. Note that there can be more than two variants in the segment and

X_{seg}≦Xₜ+X_{c}, Y_{seg}≧Yₜ+Y_{c}

Also note that the same results follow for either targeted or triggered results. It should be noted that the A/B testing system 200 doesn't have access to n_all for cross-day unless an explicit computation to deduplicate is performed.

### Count Metrics

In some embodiments, the system 200 may compute site-wide impact for count metrics as the percentage change between an average member in the “treatment universe” and “control universe”. In the “treatment universe” where everyone gets “treatment” in the segment, the total metric value can be estimated by the sum of the affected population total and the unaffected population total. The affected population total can be estimated by the treatment sample mean multiplied by the number of units triggered into the targeted experiment. The unaffected population total can be read directly since the system 200 has access to the total metric value across the site. Since any “treatment” should not affect the size of population, the difference of total metric value between “Treatment universe” and “control universe” provides the site-wide impact value.

A description of various notations is provided in Table 1:

TABLE 1

| | Treatment | Control | Segment | |
|---|---|---|---|---|
| | (targeted or | (targeted or | (targeted or | |
| | triggered) | triggered) | triggered) | Site-wide |
| Total # of | X_t | X_c | X_seg | X_all |
| pageviews | | | | |
| Sample size | n_t | n_c | n_seg | n_all |

Consider average total page views as an example metric. In the “universe” where everyone gets “treatment” in the segment, compared with everyone getting “control”, the total number of page views can be correspondingly predicted to be

$${X}_{{all}_{treatment}} = \frac{{X}_{t}}{{n}_{t}} {n}_{seg} + ( {X}_{all} - {X}_{seg} ) , {X}_{{all}_{control}} = \frac{{X}_{c}}{{n}_{c}} {n}_{seg} + ( {X}_{all} - {X}_{seg} )$$

The site-wide impact on average page view is then estimated to be

$$\begin{matrix}sitewide delta \% = ( \frac{{X}_{{all}_{treatment}}}{{n}_{{all}_{treatment}}} - \frac{{X}_{{all}_{control}}}{{n}_{{all}_{control}}} ) \text{/} ( \frac{{X}_{{all}_{control}}}{{n}_{{all}_{control}}} ) \\ = ( \frac{{X}_{t}}{{n}_{t}} {n}_{seg} - \frac{{X}_{c}}{{n}_{c}} {n}_{seg} ) \text{/} ( \frac{{X}_{c}}{{n}_{c}} {n}_{seg} + ( {X}_{all} - {X}_{seg} ) ) \\ sitewide absolute = ( {X}_{{all}_{treatment}} - {X}_{{all}_{control}} ) = ( \frac{{X}_{t}}{{n}_{t}} {n}_{seg} - \frac{{X}_{c}}{{n}_{c}} {n}_{seg} )\end{matrix}$$

The equation follows because the experiment should not impact the total sample size (assume the sample ratio passes test), i.e.

nₐₗₗ_{_{control}}nₐₗₗ_{_{control}}=nₐₗₗ

Notice that in the site-wide absolute equation above, the A/B testing system 200 does not need to access n_all. The site-wide absolute equation can be reorganized to be approximately (delta % between treatment and control)*(X_seg/X_all). Note that this is essentially introducing a multiplier indicating the size of the segment (not in terms of sample size, but in terms of the metric value to adjust for the population differences).

### Ratio Metrics

With regards to calculation of site-wide impact for ratio metrics, ratio metrics compromise of a numerator and a denominator. The total ratio value in the “treatment universe” and “control universe” are computed by the total numerator metric value divided by the total denominator metric value, which are computed like count metrics. The system 200 then computes site-wide impact as the percentage difference of the total ratio value between the two universes.

A description of various notations is provided in Table 2:

TABLE 2

| | Treatment | Control | Segment | Site-wide |
|---|---|---|---|---|
| Total # clicks | X_t | X_c | X_seg | X_all |
| Total # of | Y_t | Y_c | Y_seg | Y_all |
| pageviews | | | | |
| Sample size | n_t | n_c | n_seg | n_all |

Most of the description in the “Count Metrics” section follows, except that it can no longer be assumed that

Yₐₗₗ_{_{control}}=Yₐₗₗ_{_{control}}=Yₐₗₗ

Instead, what results is:

$${Y}_{{all}_{treatment}} = \frac{{Y}_{t}}{{n}_{t}} {n}_{seg} + ( {Y}_{all} - {Y}_{seg} ) , {Y}_{{all}_{control}} = \frac{{Y}_{c}}{{n}_{c}} {n}_{seg} + ( {Y}_{all} - {Y}_{seg} )$$

The site-wide impact for CTR can be estimated to be

$$sitewide delta \% = ( \frac{{X}_{{all}_{treatment}}}{{Y}_{{all}_{treatment}}} - \frac{{X}_{{all}_{control}}}{{Y}_{{all}_{control}}} ) \text{/} ( \frac{{X}_{{all}_{control}}}{{Y}_{{all}_{control}}} )$$

The site-wide absolute value is:

$$sitewide absolute = ( \frac{{X}_{{all}_{treatment}}}{{Y}_{{all}_{treatment}}} - \frac{{X}_{{all}_{control}}}{{Y}_{{all}_{control}}} )$$

### Uniques Metrics

With regards to calculation of site-wide impact for Unique metrics, the difference between unique metric and count metric is that unaffected population total is not readily available because the total metric value across the site and across multiple days is not readily available unless the system 200 performs an explicit deduplication. Noting that site-wide impact can be rearranged to be the local percentage change multiplied by a fraction number, alpha, which indicates the size of the segment (not in terms of sample size, but in terms of the metric value to adjust for the population differences.) The system 200 utilizes the average alpha across different days to estimate alpha, and then compute site-wide impact.

A description of various notations is provided in Table 3:

TABLE 3

| | Treatment | Control | Segment | Site-wide |
|---|---|---|---|---|
| Total homepage | X_t | X_c | X_seg | X_all |
| unique visitors | | | | |
| Sample size | n_t | n_c | n_seg | n_all |

The calculations for “uniques metrics” are similar to the “count metrics” calculations, except that X_all is not known directly unless it is a single day. This is similar to the formula for the count metrics:

$$sitewide delta \% = \frac{\frac{{X}_{t}}{{n}_{t}} {n}_{seg} - \frac{{X}_{c}}{{n}_{c}} {n}_{seg}}{\frac{{X}_{c}}{{n}_{c}} {n}_{seg}} * \frac{\frac{{X}_{c}}{{n}_{c}} {n}_{seg}}{\frac{{X}_{c}}{{n}_{c}} {n}_{seg} + ( {X}_{all} - {X}_{seg} )} = \frac{\frac{{X}_{t}}{{n}_{t}} - \frac{{X}_{c}}{{n}_{c}}}{\frac{{X}_{c}}{{n}_{c}}} * α$$

Note that (site-wide delta %)=(delta %)*alpha. Since the A/B testing system 200 has single day data for X_{all,d}, X_{c,d}, X_{seg,d}, n_{c,d}, and n_{seg,d}, the A/B testing system 200 can access the value of the scale factor alpha_d for day d. In some embodiments, the A/B testing system 200 may apply the average of alpha_d to produce the cross-day scale factor alpha. i.e. for cross-day from day 1 to day D, the following results:

$$α = \frac{1}{D} {\sum }_{d = 1}^{D} {α}_{d} = \frac{1}{D} {\sum }_{d = 1}^{D} \frac{\frac{{X}_{c , d}}{{n}_{c , d}} {n}_{seg , d}}{\frac{{X}_{c , d}}{{n}_{c , d}} {n}_{seg , d} + ( {X}_{all , d} - {X}_{seg , d} )}$$

$$sitewide absolute = ( {X}_{{all}_{treatment}} - {X}_{{all}_{control}} ) = ( \frac{{X}_{t}}{{n}_{t}} {n}_{seg} - \frac{{X}_{c}}{{n}_{c}} {n}_{seg} )$$

While examples herein refer to metrics such as a number of page views associated with a webpage, a number of unique visitors associated with a webpage, and a click-through rate associated with an online content item, such metrics are merely exemplary, and the techniques described herein are applicable to any type of metric that may be measure during an online A/B experiment, such as profile completeness score, revenue, average page load time, etc.

### Example Mobile Device

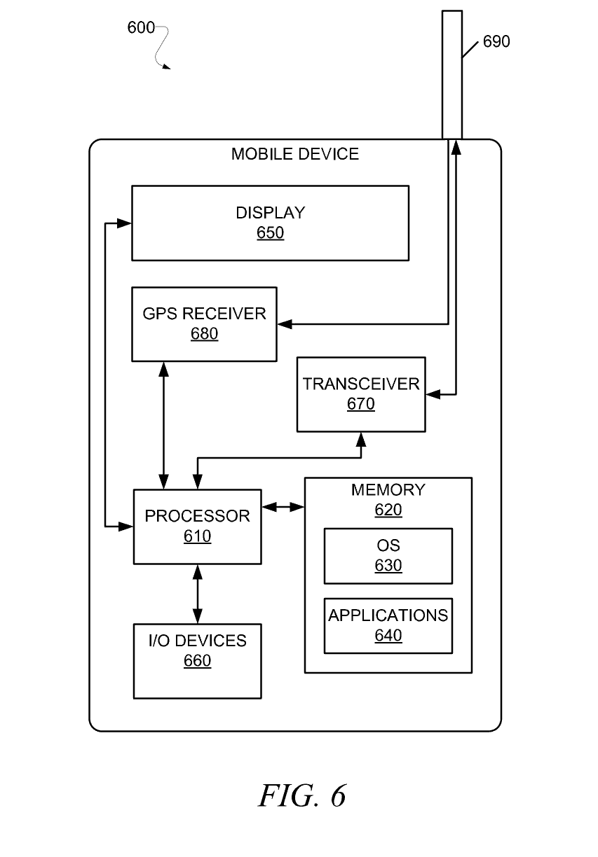

FIG. 6 is a block diagram illustrating the mobile device 600, according to an example embodiment. The mobile device may correspond to, for example, one or more client machines or application servers. One or more of the modules of the system 200 illustrated in FIG. 2 may be implemented on or executed by the mobile device 600. The mobile device 600 may include a processor 610. The processor 610 may be any of a variety of different types of commercially available processors suitable for mobile devices (for example, an XScale architecture microprocessor, a Microprocessor without Interlocked Pipeline Stages (MIPS) architecture processor, or another type of processor). A memory 620, such as a Random Access Memory (RAM), a Flash memory, or other type of memory, is typically accessible to the processor 610. The memory 620 may be adapted to store an operating system (OS) 630, as well as application programs 640, such as a mobile location enabled application that may provide location based services to a user. The processor 610 may be coupled, either directly or via appropriate intermediary hardware, to a display 650 and to one or more input/output (I/O) devices 660, such as a keypad, a touch panel sensor, a microphone, and the like. Similarly, in some embodiments, the processor 610 may be coupled to a transceiver 670 that interfaces with an antenna 690. The transceiver 670 may be configured to both transmit and receive cellular network signals, wireless data signals, or other types of signals via the antenna 690, depending on the nature of the mobile device 600. Further, in some configurations, a GPS receiver 680 may also make use of the antenna 690 to receive GPS signals.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

Example Machine Architecture and Machine-Readable Medium

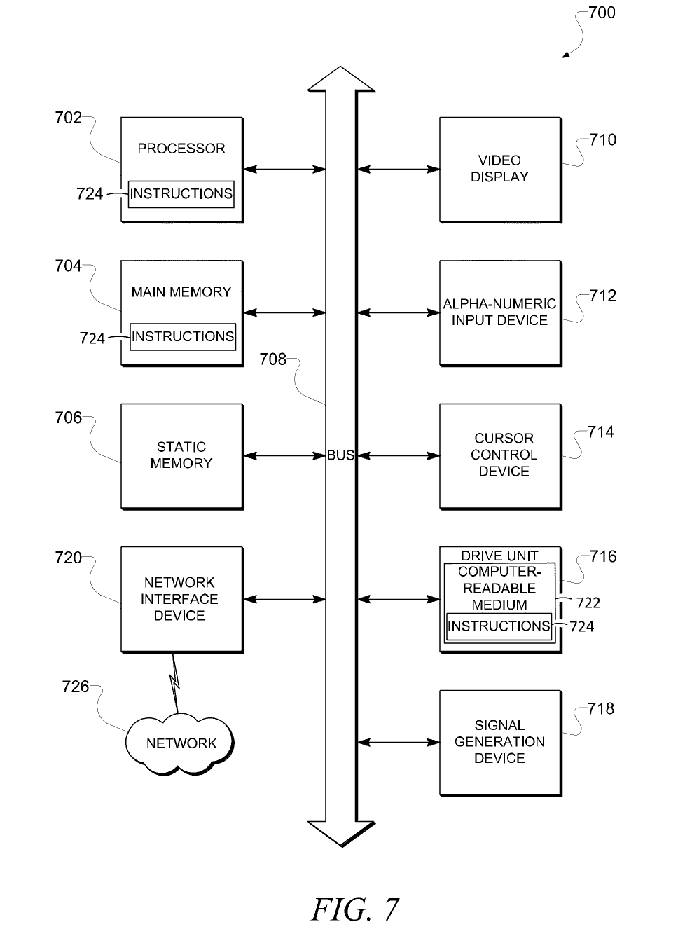

FIG. 7 is a block diagram of machine in the example form of a computer system 700 within which instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 700 includes a processor 702 (e.g., a central processing unit (CPU), a graphics processing unit (GPU) or both), a main memory 704 and a static memory 706, which communicate with each other via a bus 708. The computer system 700 may further include a video display unit 710 (e.g., a liquid crystal display (LCD) or a cathode ray tube (CRT)). The computer system 700 also includes an alphanumeric input device 712 (e.g., a keyboard or a touch-sensitive display screen), a user interface (UI) navigation device 714 (e.g., a mouse), a disk drive unit 716, a signal generation device 718 (e.g., a speaker) and a network interface device 720.

### Machine-Readable Medium

The disk drive unit 716 includes a machine-readable medium 722 on which is stored one or more sets of instructions and data structures (e.g., software) 724 embodying or utilized by any one or more of the methodologies or functions described herein. The instructions 724 may also reside, completely or at least partially, within the main memory 704 and/or within the processor 702 during execution thereof by the computer system 700, the main memory 704 and the processor 702 also constituting machine-readable media.

While the machine-readable medium 722 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present disclosure, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

### Transmission Medium

The instructions 724 may further be transmitted or received over a communications network 726 using a transmission medium. The instructions 724 may be transmitted using the network interface device 720 and any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., WiFi, LTE, and WiMAX networks). The term “transmission medium” shall be taken to include any intangible medium that is capable of storing, encoding or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A method comprising:
receiving a user specification of an online A/B experiment of online content being targeted at a segment of members of an online social networking service, a treatment variant of the A/B experiment being applied to a subset of the segment of members;
accessing a value of a metric associated with application of the treatment variant of the A/B experiment to the subset of the segment of members;
calculating, using one or more hardware processors, a site-wide impact value for the A/B experiment that is associated with the metric, the site-wide impact value indicating a predicted percentage change in the value of the metric responsive to application of the treatment variant to an entire portion of the targeted segment of members, in comparison to application of a control variant to an entire portion of the targeted segment of members; and
displaying, via a user interface displayed on a client device, the site-wide impact value.

2. The method of claim 1, further comprising:
calculating a plurality of site-wide impact values for a plurality of segments of members associated with the A/B experiment; and
summing the plurality of site-wide impact values to generate a total site-wide impact value.

3. The method of claim 1, wherein the metric is a number of page views associated with a webpage.

4. The method of claim 1, wherein the metric is a number of unique visitors associated with a webpage.

5. The method of claim 1, wherein the metric is a number of clicks associated with an online content item.

6. The method of claim 1, wherein the metric is a click-through rate associated with an online content item.

7. A system comprising:
a processor; and
a memory device holding an instruction set executable on the processor to cause the system to perform operations comprising:
receiving a user specification of an online A/B experiment of online content being targeted at a segment of members of an online social networking service, a treatment variant of the A/B experiment being applied to a subset of the segment of members;
accessing a value of a metric associated with application of the treatment variant of the A/B experiment to the subset of the segment of members;
calculating a site-wide impact value for the A/B experiment that is associated with the metric, the site-wide impact value indicating a predicted percentage change in the value of the metric responsive to application of the treatment variant to an entire portion of the targeted segment of members, in comparison to application of a control variant to an entire portion of the targeted segment of members; and
displaying, via a user interface displayed on a client device, the site-wide impact value.

8. The system of claim 7, wherein the operations further comprise:
calculating a plurality of site-wide impact values for a plurality of segments of members associated with the A/B experiment; and
summing the plurality of site-wide impact values to generate a total site-wide impact value.

9. The system of claim 7, wherein the metric is a number of page views associated with a webpage.

10. The system of claim 7, wherein the metric is a number of unique visitors associated with a webpage.

11. The system of claim 7, wherein the metric is a number of clicks associated with an online content item.

12. The system of claim 7, wherein the metric is a click-through rate associated with an online content item.

13. A non-transitory machine-readable storage medium comprising instructions that, when executed by one or more processors of a machine, cause the machine to perform operations comprising:
receiving a user specification of an online A/B experiment of online content being targeted at a segment of members of an online social networking service, a treatment variant of the A/B experiment being applied to a subset of the segment of members;
accessing a value of a metric associated with application of the treatment variant of the A/B experiment to the subset of the segment of members;
calculating a site-wide impact value for the A/B experiment that is associated with the metric, the site-wide impact value indicating a predicted percentage change in the value of the metric responsive to application of the treatment variant to an entire portion of the targeted segment of members, in comparison to application of a control variant to an entire portion of the targeted segment of members; and
displaying, via a user interface displayed on a client device, the site-wide impact value.

14. The storage medium of claim 13, wherein the operations further comprise:
calculating a plurality of site-wide impact values for a plurality of segments of members associated with the A/B experiment; and
summing the plurality of site-wide impact values to generate a total site-wide impact value.

15. The storage medium of claim 13, wherein the metric is a number of page views associated with a webpage.

16. The storage medium of claim 13, wherein the metric is a number of unique visitors associated with a webpage.

17. The storage medium of claim 13, wherein the metric is a number of clicks associated with an online content item.

18. The storage medium of claim 13, wherein the metric is a click-through rate associated with an online content item.
